(19) United States
(12) Patent Application Publication
(10) Pub. No.: US 2023/0322021 A1
(43) Pub. Date: Oct. 12, 2023

(54) BICYCLE WHEEL HUB STRUCTURE

(71) Applicant: MENG-LUNG YANG, Changhua County (TW)

(72) Inventor: MENG-LUNG YANG, Changhua County (TW)

(21) Appl. No.: 17/748,874

(22) Filed: May 19, 2022

(30) Foreign Application Priority Data
Mar. 23, 2022 (TW) 111110723

(51) Int. Cl. B60B 1/04; B60B 27/02

(52) U.S. Cl. CPC B60B 27/023; B60B 1/041; B60B 1/042

(57) ABSTRACT

The invention relates to bicycle wheel hub structure, wherein two sides of wheel hub’s hub body are provided with wheel hub disc sets. The wheel hub disc sets are spaced with outer and inner hub discs. When assembled with several wheel spokes and a wheel frame, one end of the several wheel spokes is fixedly combined with the wheel frame and the other end of which is fixedly combined with the outer hub disc and the inner wheel hub respectively, so to disperse the stress generated by the wheel spokes, avoiding excessive force on the outer hub or inner hub. The outer and the inner hub discs are arranged at intervals, so that the spokes will be in contact with each other when assembled, reducing friction and affecting structural strength and service life, and achieving convenient structural use and good structural use function.

### FIELD

The present invention relates to a bicycle wheel hub structure, especially a kind of wheel hub which is applied to disperse the force of the steel wire between the bicycle wheel frame and the wheel hub, enhance the pulling force and reduce the friction between the steel wires, which belongs to the technical field.

### BACKGROUND

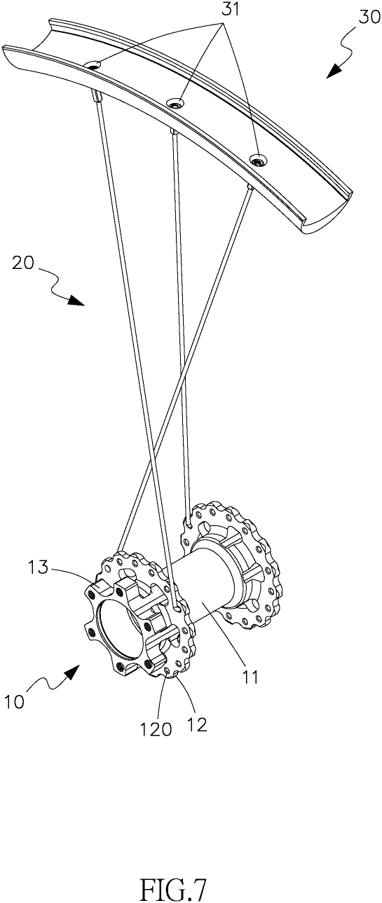

Referring to FIG. 7, the structure of the conventional bicycle hub is shown therein. The hub 10 includes a hub body 11 and at least two hub discs 12. The hub discs 12 are oppositely disposed on both sides of the hub body 11 and are in the same direction as the edge of the hub body 11. The hub 12 is provided with several spoke fixing holes 120 at equal intervals. By fitting the hub 10 with several spokes 20 and a wheel frame 30, the wheel frame 30 is provided with several positioning combining holes 31 at intervals. One end of the bar 20 is respectively fixed to the wheel spoke fixing holes 120 provided in the hub plate 12, and the other ends of the plurality of wheel spokes 20 are respectively fixed to the number of positioning and combining holes 31 provided in the wheel frame 30, and the wheel spokes 20 are crossed. The state is set, and the middle sections of the spokes 20 of each wheel are in contact with each other, and then the weight and force are carried by the front and rear wheels respectively when the bicycle is in contact with the ground, and the overall force will be concentrated on the hub 12 combined with the spokes 20 of the wheels. The number of wheel spoke fixing holes 120 is set, so the force around the wheel spoke fixing holes 120 is concentrated, and there is a problem of structural stability. In addition, the wheel spokes 20 in the crossed state contacting and abutting each other in the middle section will be affected by the hub body 11. The friction at the abutting position of the spokes 20 caused by the force also reduces the strength and service life of the spokes 20, so there is a need for improvement.

### SUMMARY OF THE DISCLOSURE

In view of the problems of insufficient structural stability, structural strength and service life of the conventional bicycle hub structure, the present invention completes the bicycle hub structure of the present invention.

The main purpose of the present invention is to provide a bicycle wheel hub structure, wherein the wheel hub system includes a wheel hub body, a ratchet disk and at least two wheel hub disk sets. The outer diameter of the outer hub is larger than the outer diameter of the inner hub, and the outer hub is staggered with several fixed protrusions and several recesses, and the fixed protrusions are respectively provided with an outer fixing hole, and the inner hub is relatively outer. The number of hub discs is such that the recessed portions are respectively provided with an inner fixing hole, the hub disc sets are respectively arranged on two sides of the hub body, and the ratchet discs are arranged on the outer side of the hub disc set on one side of the hub body.

In a preferred embodiment, it further comprises several wheel spokes and a wheel frame, the number of fixed convex portions of the outer hub disk is provided with an inclined cut surface relative to the side surface of the ratchet disk, and one end of the number of wheel spokes is fixed on the wheel frame, the other ends of the spokes are fixed on the outer fixing holes of the fixed convex part of the outer hub, and the inclined cut surface of the fixed convex part prevents the friction between the spokes and the fixed convex part, so as to increase the number of wheels. The rigidity and service life of the spoke structure enhances the multiple variability of the present invention.

In a preferred embodiment, it further includes a number of spokes and a frame, the inner fixing holes of the inner hub are provided with an outwardly open avoidance recess, one end of the spokes is fixed on the frame, and the spokes are fixed on the frame. When the other end of the strip is fixed in the outer fixing hole of the fixed convex part of the outer wheel hub, the recessed part is used to avoid the several wheel spokes during assembly, which is convenient for assembling and fixing, so as to improve the multi-variability of the present invention.

In a preferred embodiment, the avoidance recess of the inner hub is further provided with a trough, and the depth of the trough is lower than the outer diameter of the outer fixing hole provided in the outer hub, and the spokes are fixed on the outer hub. When the number of fixed convex parts of the disk are provided with external fixing holes, the valleys of the recessed parts are used to avoid the number of spokes during assembly, so that the spokes do not contact the inner hub disk, and the endurance strength and service life of the spokes are improved. Multiple variations of the invention are provided.

The two sides of the hub body of the wheel hub are respectively provided with a hub disk group, and the wheel hub disk group is provided with an outer hub disk and an inner hub disk at intervals. The frame is fixedly combined, and the other ends of the spokes are fixedly combined with the outer hub and the inner hub respectively. The force generated by the scattered spokes is applied to the outer hub and the inner hub, so as to avoid the outer hub or the inner hub from being overburdened. The outer hub disc and the inner hub disc are arranged at intervals, so that the spokes of several wheels will come into contact with each other when they are assembled, reducing friction and affecting the strength and service life of the structure, so as to achieve the convenience and function of the structure.

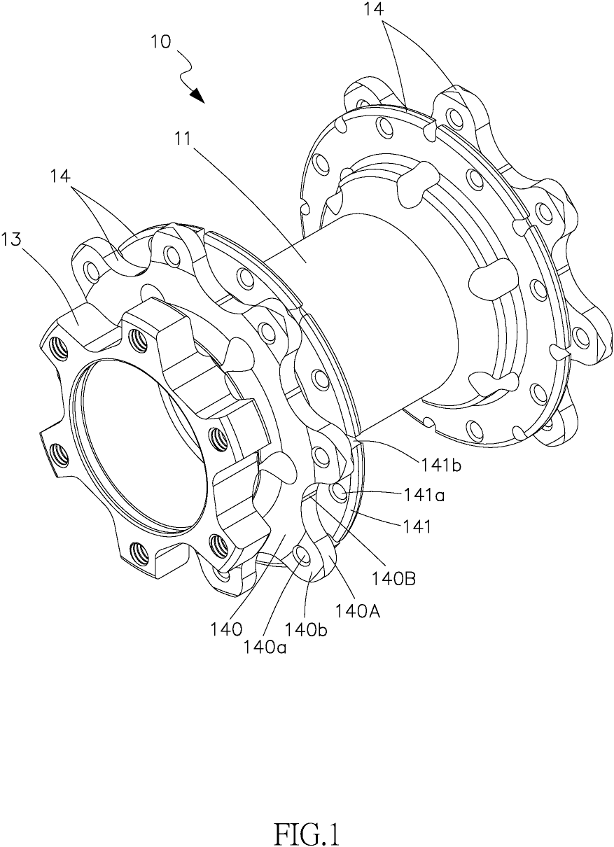

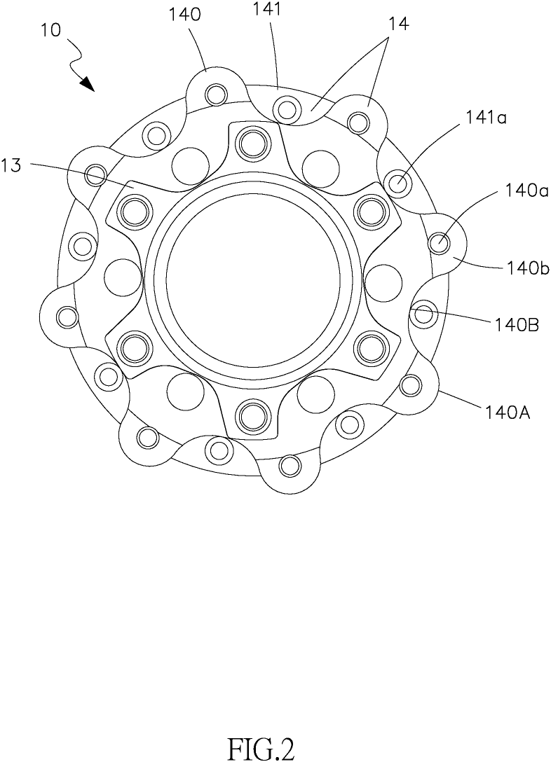

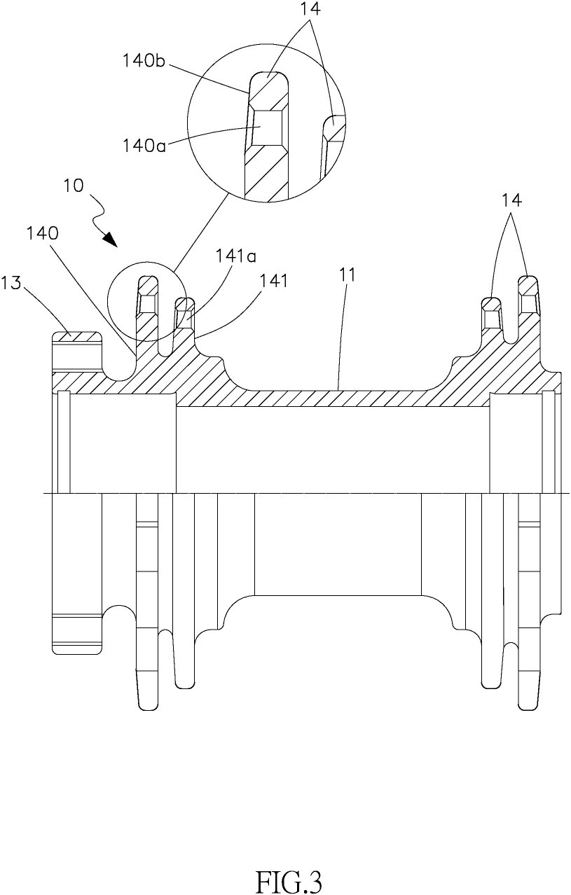

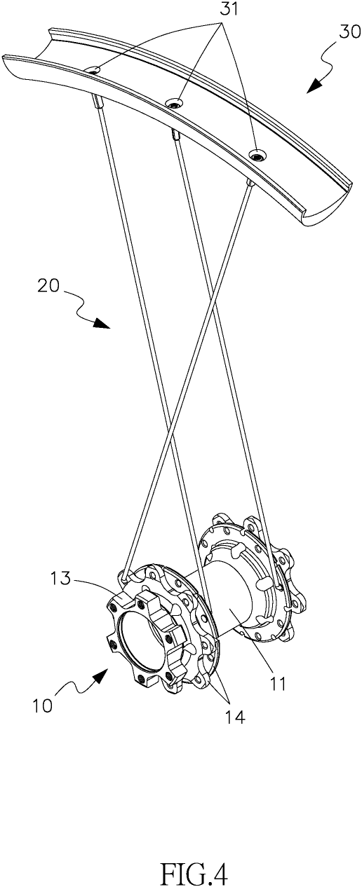

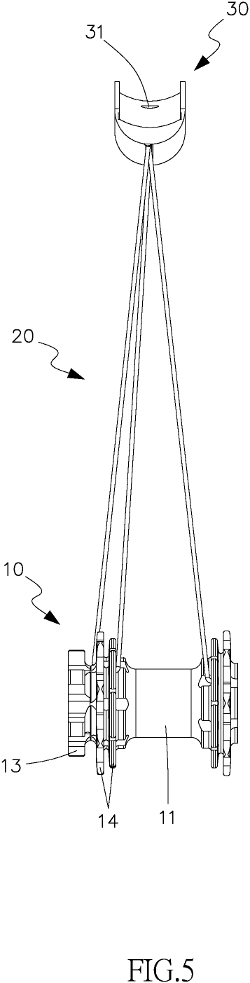

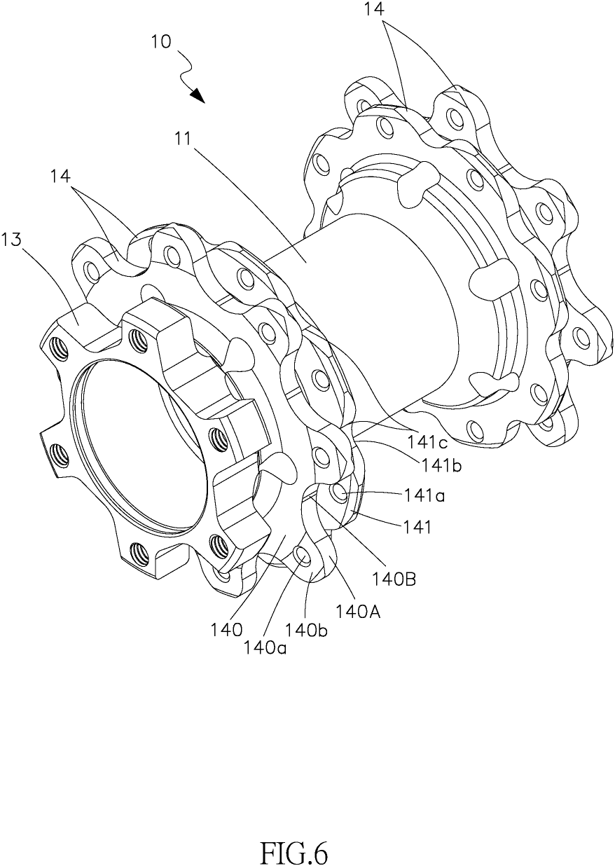

### BRIEF DESCRIPTION OF THE DRAWINGS

[FIG. 1] is a three-dimensional schematic diagram of the structure of the bicycle wheel hub of the present invention.

[FIG. 2] It is a schematic view of the bicycle wheel hub structure of the present invention as seen before.

[FIG. 3] It is a side view half-section and a partial enlarged state reference view of the bicycle wheel hub structure of the present invention.

[FIG. 4] It is a reference view of the three-dimensional use state of the bicycle hub structure of the present invention assembled with the spokes and the wheel frame.

[FIG. 5] It is a side view of the use state reference diagram of the assembly of the spokes and the wheel frame of the bicycle hub structure of the present invention.

[FIG. 6] is a reference diagram of the state in which the depth of the trough of the recessed portion provided in the inner hub is lower than the outer diameter of the outer fixing hole provided in the outer hub, according to the embodiment of the bicycle hub structure of the present invention.

[FIG. 7] is a reference view of a three-dimensional state of a conventional bicycle hub structure of the bicycle hub structure of the present invention.

### DETAILED DESCRIPTION

In order to enable your examiners to further understand the structure, features and other purposes of the present invention, the following preferred embodiments are described in detail with drawings as follows, but the embodiments described in the drawings are for illustrative purposes. Not the only limitation on patent applications.

Reference is collectively made to FIGS. 1 to 3, which are the three-dimensional state, front-view state, side-view half-section and partial enlarged state reference diagram of the bicycle hub structure of the present invention, which include:

A hub 10, the hub 10 is provided with a hub body 11, a ratchet disc 13 and at least two hub disc sets 14, the hub disc sets 14 are respectively provided with an outer hub disc 140 and an inner hub disc 141, the outer diameter of the outer hub 140 is larger than the outer diameter of the inner hub 141, and the outer hub 140 is alternately provided with several fixing protrusions 140A and several recesses 140B, and the fixing protrusions 140A are respectively provided with an outer fixing hole 140a, the inner hub plate 141 is provided with an inner fixing hole 141a in the number of recesses 140B relative to the number of the outer hub plate 140, and the hub plate group 14 is respectively arranged on both sides of the hub body 11, and the ratchet plate 13 is arranged on the hub. The outer side of the hub disk assembly 14 on one side of the main body 11.

Through the cooperation of the above structures, the bicycle wheel hub structure of the present invention is completed.

Reference is next made to FIGS. 1 to 5, which are the three-dimensional state, front-view state, side-view half-section and partial enlarged state of the bicycle hub structure of the present invention, the three-dimensional use state assembled with the spokes and the wheel frame, and the spokes and the wheel frame. Referring to the assembled side view of the use state, the hub 10 is provided with hub disc sets 14 on both sides of the hub body 11. The hub disc set 14 is provided with an outer hub disc 140 and an inner hub disc 141 at intervals. 20 and the wheel frame 30 are assembled, one end of the number of wheel spokes 20 is fixedly combined with the wheel frame 30, and the other end of the number of wheel spokes 20 is fixedly combined with the outer hub disk 140 and the inner hub disk 141 respectively. The outer hub 140 and the inner hub 141 are subjected to force to prevent the outer hub 140 or the inner hub 141 from being subjected to excessive force, and the outer hub 140 and the inner hub 141 are arranged at intervals to allow the number of spokes 20. During assembly, the parts will come into contact with each other, reducing friction and affecting the structural strength and service life, so as to achieve the effect of convenient use of the structure and good function of the structure.

Reference is again made to FIG. 3, which is a side view of a half-section and a partial enlarged state reference view of the bicycle hub structure of the present invention. In a preferred embodiment, it further includes several spokes 20 and a wheel frame 30. The number of fixed protrusions 140A is provided with an inclined cut surface 140b relative to the side surface of the ratchet plate 14. One end of the number of spokes 20 is fixed to the wheel frame 30, and the other end of the number of spokes 20 is fixed to the outer hub 140. The outer fixing holes 140a are provided on the convex portion 140A, and the inclined cut surface portion 140b provided on the fixing convex portion 140A prevents friction between the spokes 20 and the fixing convex portions 140A, thereby improving the rigidity and service life of the spokes 20. The multiple variability of the present invention is enhanced.

Reference again made back to FIG. 1, which is a three-dimensional schematic diagram of the structure of the bicycle hub of the present invention. In a preferred embodiment, it further includes several spokes 20 and a wheel frame 30. The inner hub disk 141 has a fixed hole. Between 141a, there is an outwardly opening avoiding recess 141b, one end of several spokes 20 is fixed on the wheel frame 30, and the other end of the several spokes 20 is fixed on the outer hub 140. When the hole 140a is formed, the avoidance concave portion 141b is used for avoidance when the spokes 20 of the wheel are assembled, so as to facilitate the assembly and fixation, so as to enhance the multiple variability of the present invention.

Reference is made to FIG. 6, which is a reference diagram of a state in which the depth of the troughs of the recesses provided in the inner hub is lower than the outer diameter of the outer fixing holes provided in the outer hub, in a preferred embodiment of the bicycle hub structure of the present invention. Except that the recessed portion 141b of the inner hub 141 is provided with a trough 141c, and the depth of the trough 141c is lower than the outer diameter of the outer fixing hole 140a provided in the outer hub 140, when the spokes 20 are fixed on the outer fixing holes 140a of the fixing protrusions 140A of the outer hub 140, the valleys 141c of the recessed portions 141b are used to avoid the spokes 20 when they are assembled, so that the spokes 20 are not in contact with the inner hub 140. The contact between the hub disks 141 increases the endurance strength and service life of the spokes 20, so as to increase the multiple variability of the present invention.

To sum up, the present invention can indeed achieve the above-mentioned functions and purposes, so the present invention should meet the requirements for a patent application, and an application should be filed in accordance with the law.

1. A bicycle wheel hub structure, comprising:
a hub, wherein the hub is provided with a hub body, a ratchet disc and at least two hub disc sets, the hub disc sets are respectively provided with an outer hub disc and an inner hub disc at intervals, and the outer hub disc is staggered with several fixed protrusions and the number of recessed parts is provided, and the fixed convex parts are respectively provided with an outer fixing hole, and the number of recessed parts of the inner hub disc relative to the outer hub disc are respectively provided with an inner fixing hole, and the hub disc sets are respectively arranged on the two sides of the hub body, and the ratchet disc is arranged on the outer side of the hub disc group on one side of the hub body.

2. The bicycle wheel hub structure as claim 1, wherein the number fixing convex portion of the outer hub is provided with an inclined cut surface relative to the side surface of the ratchet plate.

3. The bicycle wheel hub structure as claim 1, wherein the inner fixing holes of the inner hub are provided with outwardly opening avoidance recesses.

4. The bicycle wheel hub structure as claim 1, wherein the outer diameter of the outer hub is larger than the outer diameter of the inner hub.

5. A bicycle wheel hub structure, comprising:
a hub, the hub is provided with a hub body, a ratchet disc and at least two hub disc sets, the hub disc sets are respectively provided with an outer hub disc and an inner hub disc at intervals, and the outer hub disc is staggered with several fixed protrusions and the number of recessed parts is provided, and the fixed convex parts are respectively provided with an outer fixing hole, and the number of recessed parts of the inner hub disc relative to the outer hub disc are respectively provided with an inner fixing hole, and the hub disc sets are respectively arranged on the two sides of the hub body, and the ratchet disc is arranged on the outside of the hub disc group on one side of the hub body;
a number of wheel spokes, one end of the wheel spokes is respectively fixed to the outer fixing holes provided in the number of fixing protrusions of the outer hub disc and the inner fixing holes provided in the inner hub disc; and
a wheel frame, the inner space of the wheel frame is fixed with the other ends of the spokes of several wheels.

6. The bicycle wheel hub structure as claim 5, wherein, the number-fixing convex portion of the outer hub plate is provided with an inclined cut surface relative to the side surface of the ratchet plate, one end of the number of spokes is fixed on the wheel frame, and the other end of the number of spokes is fixed on the number-fixing protrusion of the outer hub plate, the outer fixing holes are provided on the front part, and the inclined cut surface part provided on the number fixing convex part prevents the contact between the number of wheel spokes and the number fixing convex part to generate friction.

7. The bicycle wheel hub structure as claim 5, wherein, the inner fixing holes of the inner hub are provided with outwardly opening avoidance recesses, one end of the spokes is fixed on the wheel frame, and the other ends of the spokes are fixed on the fixing protrusions of the outer hub, when an external fixing hole is provided, the avoidance recess is used for avoidance when the spokes of several wheels are assembled.

8. The bicycle wheel hub structure as claim 5, wherein, the outer diameter of the outer hub is larger than the outer diameter of the inner hub.

9. The bicycle wheel hub structure as claim 5, wherein, the recessed portion of the inner hub is further provided with a trough, and the depth of the trough is lower than the outer diameter of the outer fixing hole provided on the outer hub, and the number of the spokes fixed to the number of the fixing protrusions of the outer hub is set, when the outer fixing hole is used, the trough of the avoidance recess is used for the avoidance of several spokes during assembly, so that the spokes do not contact the inner hub.
